(19) United States
(12) Patent Application Publication
(10) Pub. No.: US 2018/0172201 A1
(43) Pub. Date: Jun. 21, 2018

(54) DISPLAY APPARATUS

(71) Applicant: SAMSUNG ELECTRONICS CO., LTD., Suwon-si (KR)

(72) Inventors: Gyeng Joong KIM, Hwaseong-si (KR); Seung Sik TAK, Suwon-si (KR); Seung San HAN, Yongin-si (KR); Seo Joon LEE, Suwon-si (KR)

(73) Assignee: SAMSUNG ELECTRONICS CO., LTD., Suwon-si (KR)

(21) Appl. No.: 15/707,559

(22) Filed: Sep. 18, 2017

(30) Foreign Application Priority Data
Dec. 20, 2016 (KR) 10-2016-0174457

(51) Int. Cl. F16M 11/10; G06F 1/16; G12B 9/08; F16M 11/20; F16M 11/22; H04N 5/74

(52) U.S. Cl. CPC F16M 11/10; G06F 1/1601; G12B 9/08; F16M 2200/08; F16M 11/22; H04N 5/74; F16M 11/2014

(57) ABSTRACT

The display apparatus includes a display panel and a stand configured to support the display panel. The stand includes a fastening unit fastened to a lower end of a rear surface of the display panel; a first stand unit including a first base plate; a plurality of rollers provided on the first base plate, and an inner stand, the inner stand extending vertically from the first base plate at an upper portion of the first base plate and coupled to the fastening unit; and a second stand unit including a second base plate provided with a plurality of support portions and an outer stand, the outer stand extending vertically from the second base plate at an upper portion of the second base plate and being movable in a vertical direction to accommodate the inner stand.

### CROSS-REFERENCE TO RELATED APPLICATION

This application claims priority from Korean Patent Application No. 10-2016-0174457, filed on Dec. 20, 2016 in the Korean Intellectual Property Office, the disclosure of which is incorporated herein by reference.

### BACKGROUND

### 1. Field

Exemplary embodiments consistent with the present disclosure relate to a display apparatus which is easy to carry.

### 2. Description of the Related Art

In general, a display apparatus is an apparatus for displaying a screen, and includes a monitor, a television, and the like.

In recent years, as the size of display apparatuses become larger, the weight of the display apparatuses increases making it more difficult to carry.

Particularly, in manufacturing a display panel using display elements such as a liquid crystal display (LCD), an organic light emitting display (OLED), and a light emitting display (LED), various circuit components are incorporated in a stand to make the display panel thinner and lighter, making it difficult to carry the display apparatus or the stand as the weight of the stand increases

Further, a heavy-weight stand for supporting a large-sized display panel is used. Since the weight of the stand is heavy, it is difficult to carry.

### SUMMARY

Therefore, it is an aspect of the present disclosure to provide a display apparatus which is easy to carry and capable of preventing accidents that occur during transportation.

In accordance with an aspect of an exemplary embodiment, there is provided a display apparatus including: a display panel; and a stand configured to support the display panel, wherein the stand includes: a fastening unit fastened to a lower end of a rear surface of the display panel; a first stand unit comprising a first base plate, a plurality of rollers provided on the first base plate, and an inner stand extending vertically from an upper portion of the first base plate and coupled to the fastening unit; and a second stand unit including a second base plate, a plurality of support portions extending from the second base plate, and an outer stand extending vertically from the second base plate at an upper portion of the second base plate, the outer stand being movable in a vertical direction to accommodate the inner stand.

The first base plate may further include a plurality of first through holes through which the plurality of support portions passes in a vertical direction, and the inner stand may include a male threaded portion on an upper portion thereof.

The fastening unit may include a fastening plate fastened to the display panel; a housing including a first female threaded portion corresponding to the male threaded portion and coupled to the upper portion of the inner stand; and a connecting portion connecting the fastening plate to the housing.

The housing may receive an upper portion of the inner stand and an upper portion of the outer stand to form an upper outer appearance of the stand.

The second base plate may include a plurality of second through holes through which the plurality of rollers passes and the outer stand may include a receiving hole to receive the inner stand.

The outer stand may include a protrusion provided on an upper portion thereof, and the outer stand may be vertically movable by a jig engaged with the protrusion, the jig being configured to move vertically.

The jig may include a second female threaded portion corresponding to the male threaded portion, and a groove configured to engage with the protrusion.

When the jig is rotated in a first direction, the jig may be configured to move upward in a state where the jig is coupled to an upper portion of the stand so that the groove is engaged with the protrusion, and the second stand unit may be configured to move upward together with the jig.

When the second stand unit is moved upward, the plurality of support portions may be configured to pass through the plurality of first through holes respectively such that the plurality of support portions is spaced apart from a surface on which the stand is placed, and the plurality of rollers may contact the surface on which the stand is placed.

When the jig is rotated in a second direction, the jig may be configured to move downward and the second stand unit may be configured to move downward together with the jig.

When the second stand unit is moved downward, the plurality of support portions may be configured to contact the surface on which the stand is placed through the plurality of first through holes, and the plurality of rollers may be configured to be spaced apart from the ground.

The first base plate may include a plurality of insertion grooves into which a plurality of jigs is inserted, the plurality of jigs being configured to move the second stand unit in a vertical direction.

The plurality of jigs may be each provided with an inclined surface, and when the plurality of jigs is inserted into the plurality of insertion grooves, the second stand unit may be configured to move upward along the inclined surface, the plurality of support portions may be configured to pass through the plurality of first through holes respectively such that the plurality of support portions is spaced apart from the surface on which the stand is placed, and the plurality of rollers may contact the surface on which the stand is placed.

The second stand unit may be moved downward along the inclined surface when the plurality of jigs is drawn out from the plurality of insertion grooves.

When the second stand unit is moved downward, the plurality of support portions may be configured to contact the surface on which the stand is placed through the plurality of first through holes, and the plurality of rollers may be spaced apart from the surface on which the stand is placed.

In accordance with an aspect of another exemplary embodiment, there is provided a display apparatus including: a display panel; and a stand configured to support the display panel. The stand may include a fastening unit fastened to a lower end of a rear surface of the display panel; a first stand unit coupled to the fastening unit, the first stand unit including a plurality of rollers at a lower portion thereof; and a second stand unit disposed on the first stand unit so as to be movable in a vertical direction, the second stand unit being supported on the a surface on which the stand is placed by a plurality of supporting portions provided at a lower portion thereof. When the second stand unit moves upward, the plurality of supporting portions may be configured to be spaced apart from the ground and the plurality of rollers may be configured to be supported on the surface on which the stand is placed. When the second stand unit moves downward, the plurality of rollers may be configured to be spaced apart from the surface on which the stand is placed and the plurality of supporting portions may be configured to be supported on the surface on which the stand is placed.

The first stand unit may include a first base plate, the plurality of rollers being provided on the first base plate; and an inner stand extending vertically from the first base plate and configured to couple with the fastening unit.

The second stand unit may include a second base plate provided with a plurality of support portions, the second base plate being disposed on the first base plate; and an outer stand extending vertically from the second base plate at an upper portion of the second base plate, the outer stand being movable in a vertical direction to accommodate the inner stand.

The outer stand may include a protrusion provided on an upper portion thereof. The outer stand may be vertically movable by a jig engaged with the protrusion, the jig being configured to move vertically.

When the jig is rotated in a first direction, the jig may be configured to move upward, the second stand unit may be configured to be moved upward together with the jig, and when the jig is rotated in a second direction, the jig may be configured to move downward, and the second stand unit may be configured to be moved downward together with the jig.

### BRIEF DESCRIPTION OF THE DRAWINGS

The above and/or other aspects will become apparent and more readily appreciated from the following description of exemplary embodiments, taken in conjunction with the accompanying drawings of which:

FIG. 1 is a perspective view illustrating a display apparatus according to an exemplary embodiment.

FIG. 2 is a view illustrating a disassembled state of a fastening unit of a stand according to an exemplary embodiment.

FIG. 3 is a perspective view illustrating a stand unit according to an exemplary embodiment.

FIG. 4 is an exploded perspective view illustrating a bottom surface of a stand unit according to an exemplary embodiment.

FIG. 5 is a view illustrating a state where a jig is coupled to an upper portion of a stand unit according to an exemplary embodiment.

FIG. 6 is a cross-sectional view schematically illustrating a state in which a jig is coupled to an upper portion of a stand unit and rotated while a plurality of support portions is supported on the ground according to an exemplary embodiment.

FIG. 7 is a cross-sectional view schematically illustrating a state in which a jig and a second stand unit move upward by the rotation of a jig and a plurality of rollers is supported on the ground according to an exemplary embodiment.

FIG. 8 is a perspective view illustrating a bottom surface of a stand unit according to another exemplary embodiment.

FIG. 9 is an exploded perspective view illustrating a bottom surface of a first stand unit according to another exemplary embodiment.

FIG. 10 is an exploded perspective view illustrating an upper surface of a first stand unit according to another exemplary embodiment.

FIG. 11 is a bottom view illustrating a state in which a plurality of jigs is inserted into a plurality of insertion grooves formed in a first base plate according to another exemplary embodiment.

FIG. 12 is a cross-sectional view schematically illustrating a state in which a plurality of jigs is inserted into a plurality of insertion grooves formed in a first base plate in a state in which a plurality of support portions is supported on the ground in accordance with another exemplary embodiment.

FIG. 13 is a cross-sectional view schematically illustrating a state in which a plurality of jigs is inserted into a plurality of insertion grooves and a second stand unit moves upward according to another exemplary embodiment.

### DETAILED DESCRIPTION

The embodiments described herein and the configurations shown in the drawings are only examples, and various modifications may be made at the time of filing of the present application to replace the exemplary embodiments and drawings of the present specification.

In addition, the same reference numerals or symbols shown in the drawings of the present specification indicate components or components that perform substantially the same function.

Throughout the specification, the terms used are merely used to describe particular exemplary embodiments, and are not intended to limit the present disclosure.

As used herein, the singular forms “a,” “an” and “the” are intended to include the plural forms as well, unless the context clearly indicates otherwise.

Also, it is to be understood that the terms such as “include,” “have,” or the like, are intended to indicate the existence of the features, numbers, operations, components, parts, or combinations thereof disclosed in the specification, and are not intended to preclude the possibility that one or more other features, numbers, operations, components, parts, or combinations thereof may exist or may be added.

It is also to be understood that terms including ordinals such as “first,” “second” and the like used herein may be used to describe various elements, but the elements are not limited to the terms, it is used only for the purpose of distinguishing one component from another. For example, the first component may be referred to as a second component, and similarly, the second component may also be referred to as a first component.

The term “and/or” includes any combination of a plurality of related listed items or any of the plurality of related listed items.

The terms “front,” “rear,” “upper,” “lower,” “left” and “right,” etc. used in the following description are defined with reference to the drawings, and a shape and a position of each component are not limited by these terms.

Reference will now be made in detail to the exemplary embodiments, examples of which are illustrated in the accompanying drawings, wherein like reference numerals refer to like elements throughout.

For convenience of explanation, a flat display apparatus is shown as an example of the display apparatus, but the display apparatus is not limited thereto. The display apparatus may be a curved display apparatus having a curved shape and having both side ends protruded forward from the center, and a flexible (bendable or flexible) display apparatus capable of changing the curved surface state and the planar surface state.

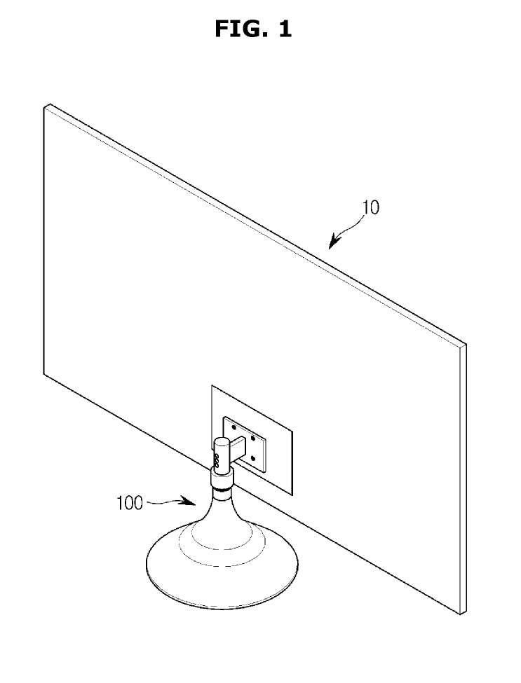

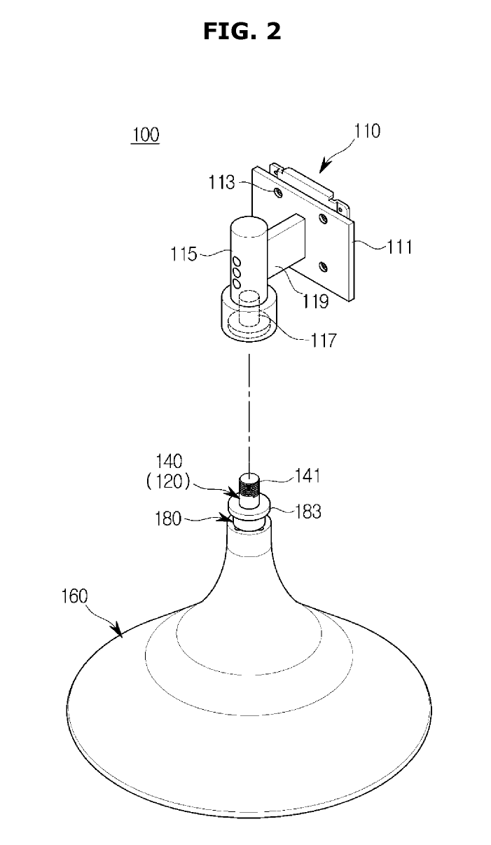

FIG. 1 is a perspective view illustrating a display apparatus according to an exemplary embodiment and FIG. 2 is a view illustrating a disassembled state of a fastening unit of a stand according to an exemplary embodiment.

As shown in FIGS. 1 and 2, the display apparatus includes a display panel 10, and a stand 100 to support the display panel 10.

The display panel 10 is provided on the front surface of a display module (not shown) for displaying a screen.

The stand 100 supports the display panel 10 at a lower portion of the display panel 10.

The stand 100 may include a fastening unit 110 fastened to the display panel 10 and stand units 120, 160 coupled to the fastening unit 110 to support the display panel 10.

The fastening unit 110 includes a fastening plate 111 fastened to a lower end of a rear surface of the display panel 10, a housing 115 coupled to an upper portion of the stand unit 120 and a connecting portion 119 to connect the fastening plate 111 and the housing 115.

The fastening plate 111 is provided with a plurality of fastening holes 113 and the fastening plate 111 is fastened to the display panel 10 by fastening members (not shown) fastened to the fastening holes 113.

The housing 115 includes a first female threaded portion 117 and the first female threaded portion 117 corresponds to a male threaded portion 141 formed on an upper portion of an inner stand 140 of the first stand unit 120 so that the housing 115 is coupled to the upper portion of the inner stand 140.

The housing 115 coupled to the upper portion of the inner stand 140 receives the upper portion of the inner stand 140 and an upper portion of an outer stand 180 to form an upper appearance of the stand 100.

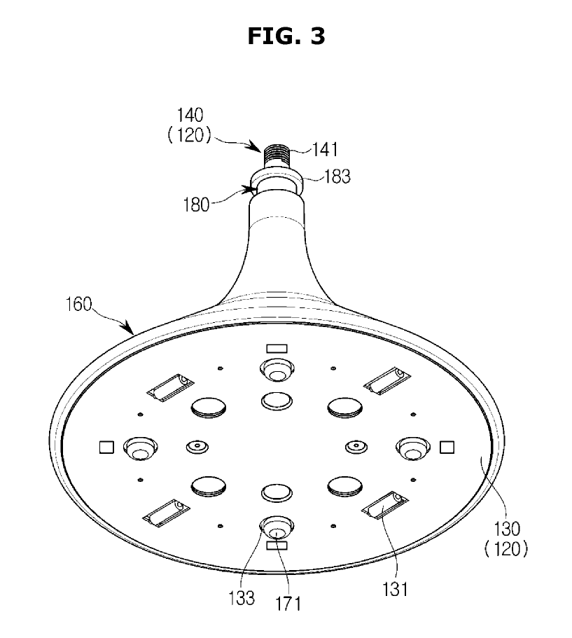

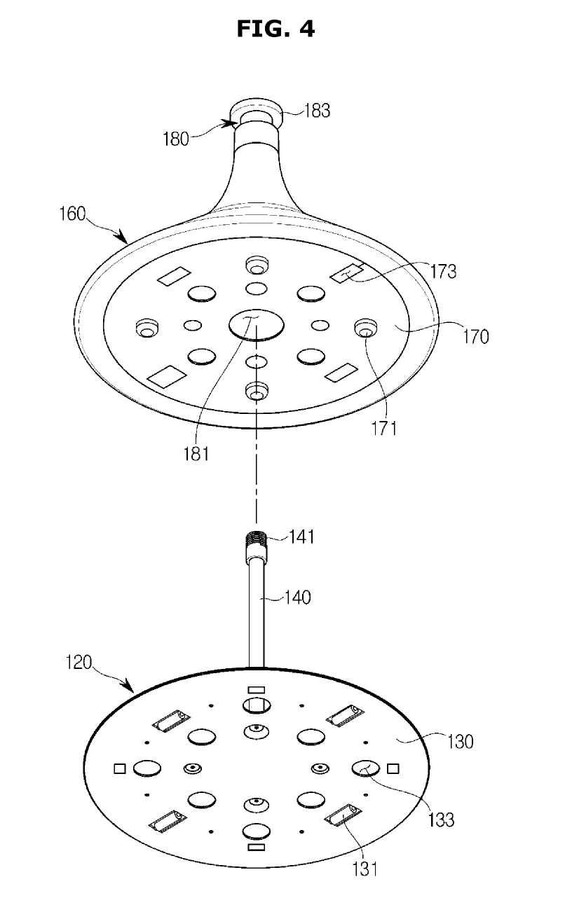

FIG. 3 is a perspective view illustrating a stand unit according to an exemplary embodiment and FIG. 4 is an exploded perspective view illustrating a bottom surface of a stand unit according to an exemplary embodiment.

As shown in FIGS. 3 and 4, the stand units 120, 160 may include the first stand unit 120 and the second stand unit 160.

The first stand unit 120 includes a first base plate 130 provided with a plurality of rollers 131 and the inner stand 140 extending perpendicularly to the first base plate 130 on the first base plate 130 and coupled to the fastening unit 110.

The plurality of rollers 131 provided at the first base plate 130 allows a user to easily move the stand units 120, 160 having a heavy weight (see FIG. 2).

In the drawings, the plurality of rollers 131 is provided at the first base plate 130 for moving the stand units 120, 160. However, the present exemplary embodiment is not limited thereto. The first base plate 130 may be provided with a member such as a bearing or the like.

In the drawings, four rollers 131 are provided at the first base plate 130, however, the present exemplary embodiment is not limited thereto, and a number of the rollers 131 may be more or less than four.

The first base plate 130 includes a plurality of first through holes 133. The plurality of first through holes 133 are provided in a number corresponding to a number of a plurality of support portions 171 provided at a second base plate 170 and the plurality of first through holes 133 allows the plurality of support portions 171 to pass through thereof in a vertical direction.

The inner stand 140 is provided to extend upward in a direction perpendicular to the first base plate 130 on the first base plate 130 and may have the male threaded portion 141 formed thereon.

The male threaded portion 141 formed on the upper portion of the inner stand 140 is provided to correspond to the first female threaded portion 117 formed on the housing 115 of the fastening unit 110 so that the housing 115 is coupled to the upper portion of the inner stand 140 (See FIG. 2).

The male threaded portion 141 formed on the upper portion of the inner stand 140 is provided to correspond to a second female threaded portion 55 formed on the jig 50 to move the second stand unit 160 in the vertical direction.

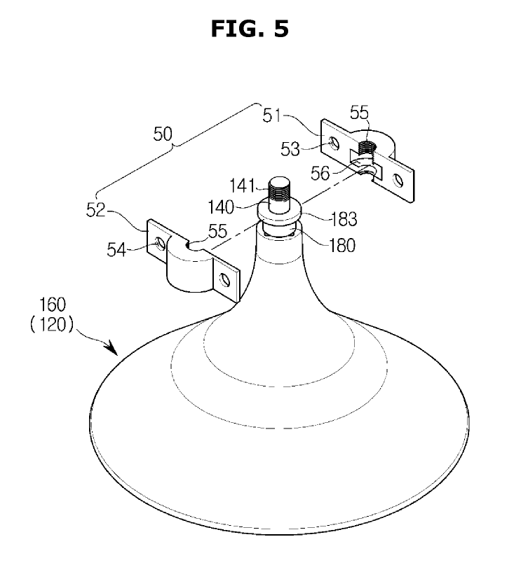

The male threaded portion 141 of the inner stand 140 and the second female threaded portion 55 of the jig 50 correspond to each other so that the user separates the fastening unit 110 from the inner stand 140 and engages the jig 50 to the upper portion of the inner stand 140 and rotates the jig 50 to move the second stand unit 160 up and down (See FIGS. 5 to 7).

The second stand unit 160 is vertically movable and includes the second base plate 170 provided with the plurality of support portions 171 and the outer stand 180 extending perpendicularly to the second base plate 170 on the second base plate 170.

The second base plate 170 is disposed above the first base plate 130 and the plurality of support portions 171 provided on the second base plate 170 is supported on the ground so that the display apparatus is supported on the ground.

The plurality of support portions 171 may be vertically moved through the plurality of first through holes 133 provided at the first base plate 130.

The plurality of support portions 171 is spaced apart from the ground in a state in which the second stand unit 160 is moved upward and the plurality of support portions 171 is supported on the ground in a state in which the second stand unit 160 is moved downward.

In the drawings, four support portions 171 are provided at the second base plate 170, however, the present exemplary embodiment is not limited thereto, and a number of the support portions 171 may be more or less than four.

The second base plate 170 further includes a plurality of second through holes 173. The plurality of second through holes 173 is provided in a number corresponding to a number of the plurality of rollers 131 provided at the first base plate 130 disposed under the second base plate 170 and the second through hole 173 is provided to receive an upper portion of the roller 131.

The outer stand 180 is provided to extend upward in a direction perpendicular to the second base plate 170 on the second base plate 170.

The outer stand 180 may have a hollow cylindrical shape and may include a receiving hole 181 in which the inner stand 140 is received and a protrusion 183 provided at an upper portion of the outer stand 180.

The receiving hole 181 is formed inside the outer stand 180 so that the outer stand 180 is movable up and down to receive the inner stand 140.

The protrusion 183 provided on the upper portion of the outer stand 180 protrudes in the circumferential direction of the outer stand 180.

The protrusion 183 is engaged with a groove 56 formed in the jig 50 for moving the second stand unit 160 in a vertical direction so that the second stand unit 160 moves in a vertical direction together with the jig 50.

Next, referring to FIGS. 5 to 7, an operation in which the second stand unit 160 is moved in a vertical direction by the jig 50 will be described.

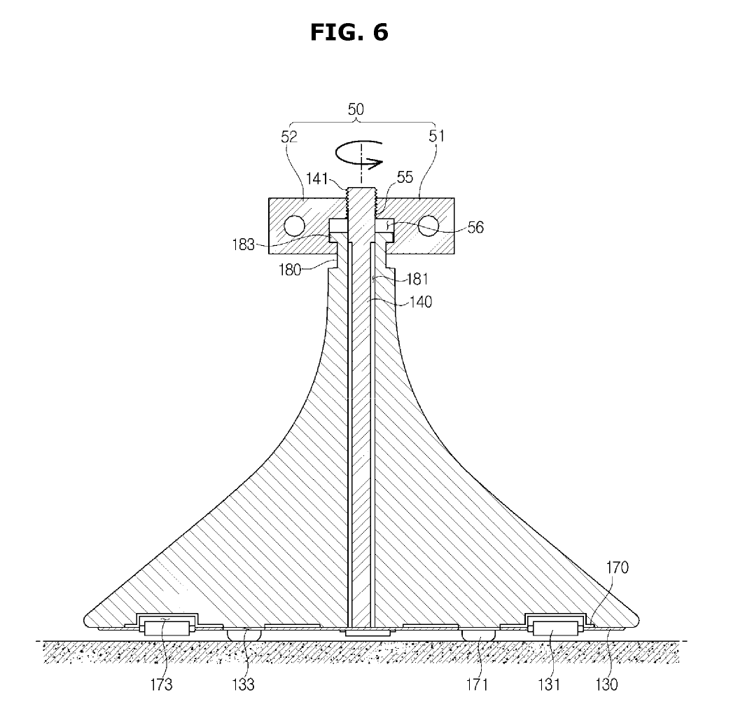

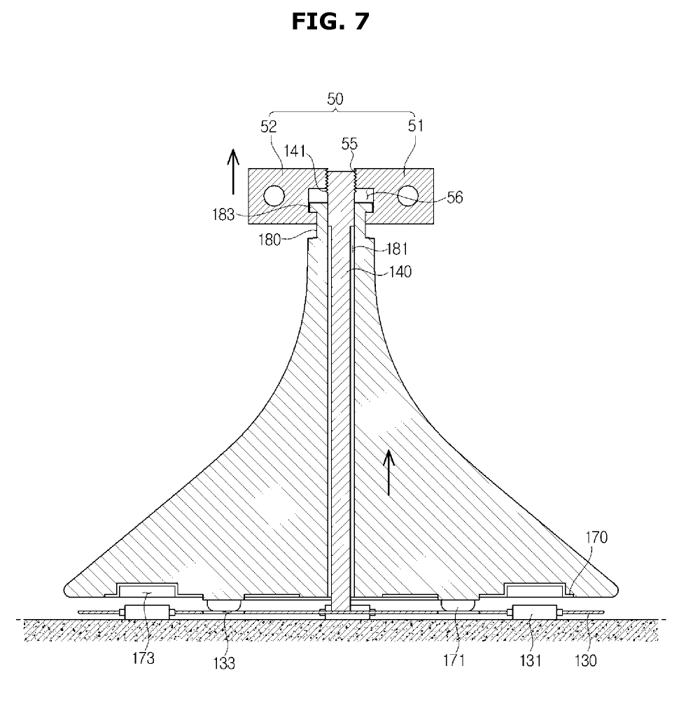

FIG. 5 is a view illustrating a state where a jig is coupled to an upper portion of a stand unit according to an exemplary embodiment and FIG. 6 is a cross-sectional view schematically illustrating a state in which a jig is coupled to an upper portion of a stand unit and rotated while a plurality of support portions is supported on the ground according to an exemplary embodiment. FIG. 7 is a cross-sectional view schematically illustrating a state in which a jig and a second stand unit move upward by the rotation of a jig and a plurality of rollers is supported on the ground according to an exemplary embodiment.

As shown in FIG. 5, the jig 50 includes a first jig unit 51 and a second jig unit 52. The first jig unit 51 and the second jig unit 52 are engaged with the upper portions of the stand units 120, 160.

The first jig unit 51 and the second jig unit 52 are engaged with each other by a member (not shown) such as a bolt engaged with a first engagement hole 53 provided in the first jig unit 51 and a second engagement hole 54 provided in the second jig unit 52.

The first jig unit 51 and the second jig unit 52 are provided with the second female threaded portion 55 and the groove 56, respectively. The jig 50 is engaged with the first stand unit 120 so that the groove 56 receives the protrusion 183 provided at the outer stand 180.

As shown in FIG. 6, when the jig 50 is engaged to an upper portion of the first stand unit 120, the second female threaded portion 55 provided on the jig 50 is able to rotate along the male threaded portion 141 formed on the inner stand 140.

When the jig 50 is rotated by the user and moves upward, the groove 56 is engaged with the protrusion 183, so that the second stand unit 160 is able to move upward together with the jig 50.

As shown in FIG. 7, when the jig 50 is rotated so as to move upward in a state in which the groove 56 is engaged with the protrusion 183, the second stand unit 160 is moved upward together with the jig 50.

When the second stand unit 160 is moved upward together with the jig 50, the plurality of support portions 171 are moved upward through the plurality of first through holes 133 so that the plurality of rollers 131 provided at the first base plate 130 is supported on the ground.

When the plurality of rollers 131 is supported on the ground, a user can easily move the stand units 120, 160 having a heavy weight.

When the jig 50 is rotated by the user after the user has moved the stand units 120, 160 to a desired position, the second stand unit 160 is moved downward together with the jig 50.

When the second stand unit 160 is moved downward together with the jig 50, the plurality of support portions 171 are moved downward through the plurality of first through holes 133 so that the plurality of support portions 171 is supported on the ground as shown in FIG. 6.

When the plurality of support portions 171 is supported on the ground, the user can separate the jig 50 from the stand units 120, 160 and couple the fastening unit 110 to the stand units 120, 160 and fasten the fastening unit 110 to the display panel 10 so that the plurality of support portions 171 supports the display panel 10.

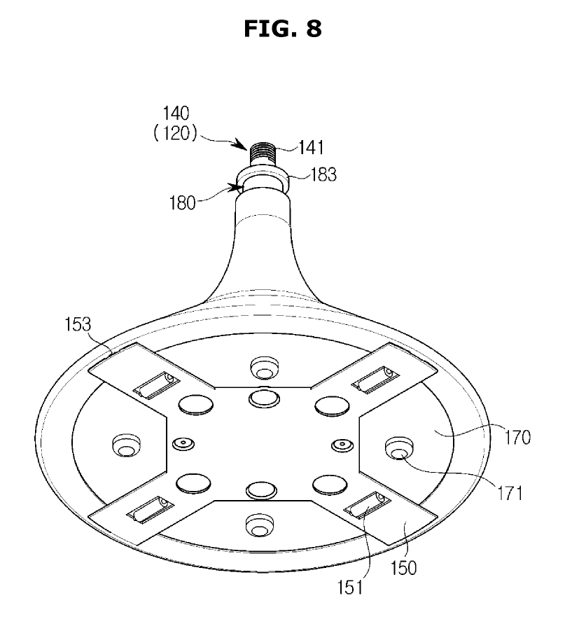

Next, another exemplary embodiment will be described with reference to FIGS. 8 to 13.

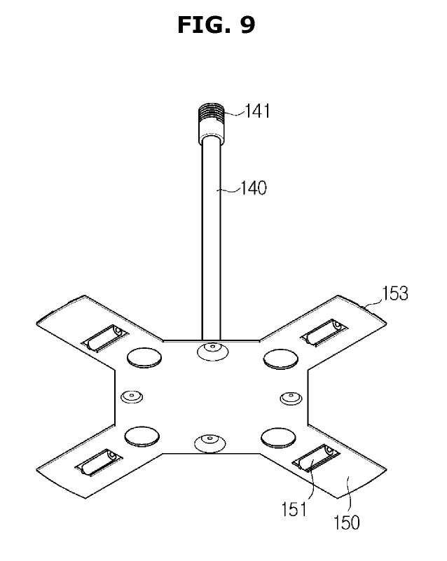

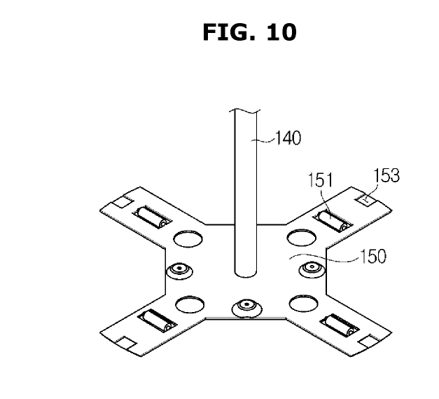

FIG. 8 is a perspective view illustrating a bottom surface of a stand unit according to another exemplary embodiment and FIG. 9 is an exploded perspective view illustrating a bottom surface of a first stand unit according to another exemplary embodiment. FIG. 10 is an exploded perspective view illustrating an upper surface of a first stand unit according to another exemplary embodiment.

As shown in FIGS. 8 to 10, the stand units 120, 160 may include the first stand unit 120 and the second stand unit 160.

A configuration in which the stand units 120, 160 include the first stand unit 120 and the second stand unit 160 is the same as the configuration illustrated in FIGS. 3 and 4.

However, a first base plate 150 included in the first stand unit 120 is different from the first base plate 130 illustrated in FIGS. 3 and 4.

Therefore, the description of the same configuration will be omitted, and only the first base plate 150 will be described.

The first base plate 150 may include a plurality of rollers 151 and a plurality of insertion grooves 153.

The plurality of rollers 151 are the same as the plurality of rollers 131 illustrated in FIGS. 3 to 4, and since the first base plate 150 is not provided to cover the entire surface of the second base plate 170, the first base plate 150 does not need to have a through hole through which the plurality of support portions 171 passes.

The plurality of insertion grooves 153 is formed on an upper surface of the first base plate 150 so that a plurality of gaps is formed between the first base plate 150 and the second base plate 170.

In the drawings, four insertion grooves 153 are provided at the first base plate 150, however, the present exemplary embodiment is not limited thereto, and a number of the insertion grooves 153 may be more or less than four.

A jig 70 for vertically moving the second stand unit 160 is inserted into the plurality of insertion grooves 153, as described below.

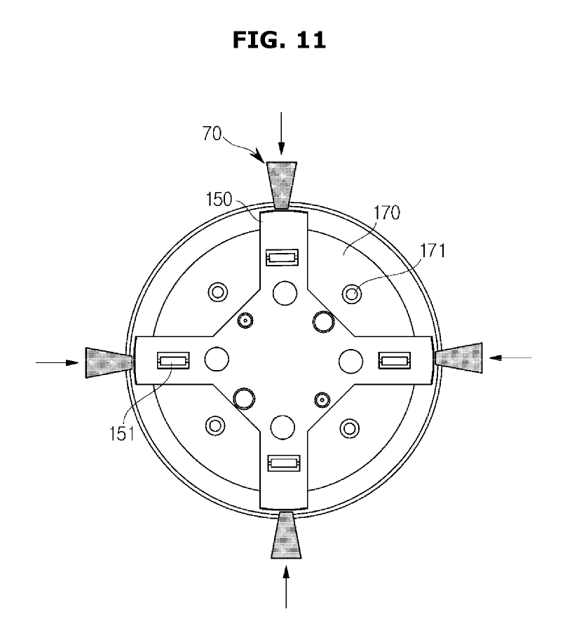

Next, referring to FIGS. 11 to 13, an operation in which the second stand unit 160 is moved in a vertical direction by the jig 70 will be described.

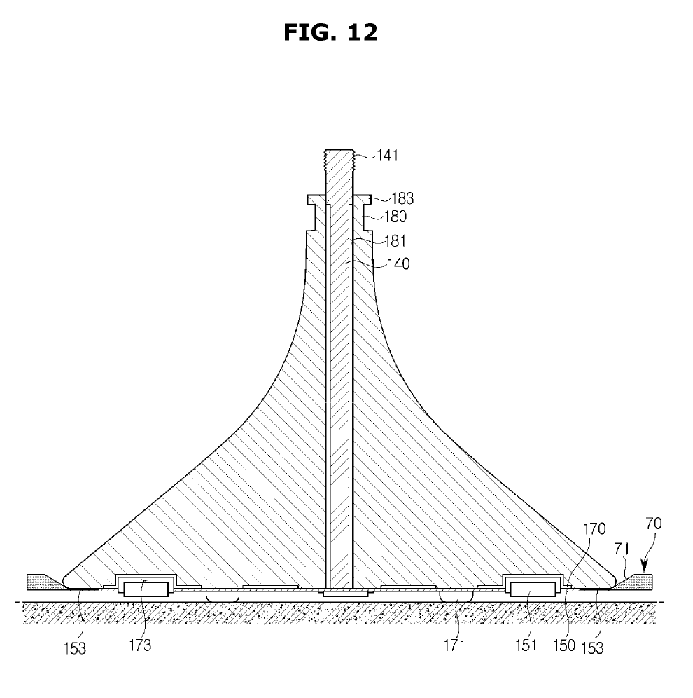

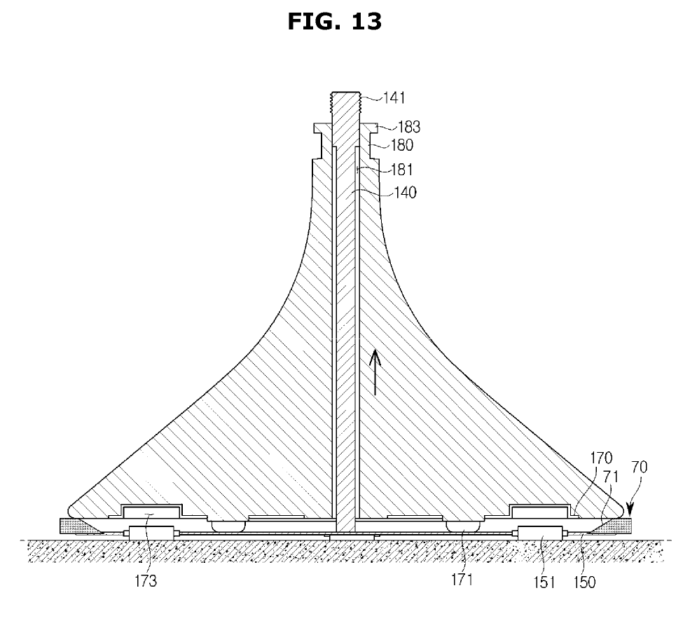

FIG. 11 is a bottom view illustrating a state in which a plurality of jigs is inserted into a plurality of insertion grooves formed in a first base plate according to another exemplary embodiment and FIG. 12 is a cross-sectional view schematically illustrating a state in which a plurality of jigs is inserted into a plurality of insertion grooves formed in a first base plate in a state in which a plurality of support portions is supported on the ground in accordance with another exemplary embodiment. FIG. 13 is a cross-sectional view schematically illustrating a state in which a plurality of jigs is inserted into a plurality of insertion grooves and a second stand unit moves upward according to another exemplary embodiment.

As shown in FIGS. 11 and 12, when the jig 70 is inserted into the plurality of insertion grooves 153 with a front surface of the jig 70 facing the plurality of insertion grooves 153 while the plurality of support portions 171 is supported on the ground, the second stand unit 160 is moved upward along an inclined surface 71 of the jig 70.

When the second stand unit 160 is moved upward, the plurality of support portions 171 is spaced apart from the ground and moved upward.

When the plurality of support portions 171 is moved upward, the plurality of rollers 151 provided on the first base plate 150 is supported on the ground.

When the plurality of rollers 151 is supported on the ground, a user can easily move the stand units 120, 160 having a heavy weight.

When the stand units 120, 160 are moved and positioned at a desired position, the plurality of jigs 70 is drawn out from the plurality of insertion grooves 153.

When the plurality of jigs 70 is drawn out from the plurality of insertion grooves 153, the second stand unit 160 is moved downward along the inclined surface 71 of the jig 70, so that the plurality of support portions 171 is supported on the ground.

When the plurality of support portions 171 is supported on the ground, the user can couple the fastening unit 110 to the stand units 120, 160 and fasten the fastening unit 110 to the display panel 10 so that the plurality of support portions 171 supports the display panel 10.

According to the exemplary embodiments, a movable stand can be easily installed on a large display panel or a wide display panel.

In addition, as the stand moves smoothly, the display panel can be prevented from falling down and the position of the display panel can be easily fixed, thereby usability is enhanced.

In addition, accidents occurring during transportation of the display apparatus are reduced.

Although a few exemplary embodiments have been shown and described, it would be appreciated by those skilled in the art that changes may be made in these exemplary embodiments without departing from the principles and spirit of the inventive concept, the scope of which is defined in the claims and their equivalents.

What is claimed is:

1. A display apparatus comprising:
a display panel; and
a stand configured to support the display panel,
wherein the stand comprises:
a fastening unit fastened to a lower end of a rear surface of the display panel;
a first stand unit comprising a first base plate, a plurality of rollers provided on the first base plate, and an inner stand extending vertically from an upper portion of the first base plate and coupled to the fastening unit; and
a second stand unit comprising a second base plate, a plurality of support portions extending from the second base plate, and an outer stand extending vertically from the second base plate at an upper portion of the second base plate, the outer stand being movable in a vertical direction to accommodate the inner stand.

2. The display apparatus according to claim 1, wherein the first base plate includes comprises a plurality of first through holes through which the plurality of support portions passes in a vertical direction, and
wherein the inner stand comprises a male threaded portion on an upper portion thereof.

3. The display apparatus according to claim 2, wherein the fastening unit comprises:
a fastening plate fastened to the display panel;
a housing comprising a first female threaded portion corresponding to the male threaded portion and coupled to the upper portion of the inner stand; and
a connecting portion connecting the fastening plate to the housing.

4. The display apparatus according to claim 3, wherein the housing receives an upper portion of the inner stand and an upper portion of the outer stand to form an upper outer appearance of the stand.

5. The display apparatus according to claim 4, wherein the second base plate comprises a plurality of second through holes through which the plurality of rollers passes, and
wherein the outer stand comprises a receiving hole to receive the inner stand.

6. The display apparatus according to claim 5, wherein the outer stand further comprises a protrusion provided on an upper portion thereof, and
wherein the outer stand is vertically movable by a jig engaged with the protrusion, the jig being configured to move vertically.

7. The display apparatus according to claim 6, wherein the jig comprises:
a second female threaded portion corresponding to the male threaded portion; and
a groove configured to engage with the protrusion.

8. The display apparatus according to claim 7, wherein when the jig is rotated in a first direction, the jig is configured to move upward in a state where the jig is coupled to an upper portion of the stand so that the groove is engaged with the protrusion, and the second stand unit is configured to move upward together with the jig.

9. The display apparatus according to claim 8, wherein when the second stand unit is moved upward, the plurality of support portions are configured to pass through the plurality of first through holes respectively such that the plurality of support portions is spaced apart from a surface on which the stand is placed, and the plurality of rollers contact the surface on which the stand is placed.

10. The display apparatus according to claim 9, wherein when the jig is rotated in a second direction, the jig is configured to move downward and the second stand unit is configured to move downward together with the jig.

11. The display apparatus according to claim 10, wherein when the second stand unit is moved downward, the plurality of support portions are configured to contact the surface on which the stand is placed through the plurality of first through holes, and the plurality of rollers is configured to be spaced apart from the surface on which the stand is placed.

12. The display apparatus according to claim 5, wherein the first base plate comprises a plurality of insertion grooves into which a plurality of jigs is inserted, the plurality of jigs being configured to move the second stand unit in a vertical direction.

13. The display apparatus according to claim 12, wherein each of the plurality of jigs is has an inclined surface, and
wherein when the plurality of jigs is inserted into the plurality of insertion grooves, the second stand unit is configured to move upward along the inclined surface, the plurality of support portions are configured to pass through the plurality of first through holes respectively such that the plurality of support portions is spaced apart from the surface on which the stand is placed, and the plurality of rollers contacts the surface on which the stand is placed.

14. The display apparatus according to claim 13, wherein the second stand unit is moved downward along the inclined surface when the plurality of jigs is drawn out from the plurality of insertion grooves.

15. The display apparatus according to claim 14, wherein when the second stand unit is moved downward, the plurality of support portions is configured to contact the surface on which the stand is placed through the plurality of first through holes, and the plurality of rollers is spaced apart from the surface on which the stand is placed.

16. A display apparatus comprising:
a display panel; and
a stand configured to support the display panel;
wherein the stand comprises:
a fastening unit fastened to a lower end of a rear surface of the display panel;
a first stand unit coupled to the fastening unit, the first stand unit comprising a plurality of rollers at a lower portion thereof; and
a second stand unit disposed on the first stand unit so as to be movable in a vertical direction, the second stand unit being supported on a surface on which the stand is placed by a plurality of supporting portions provided at a lower portion thereof;
wherein when the second stand unit moves upward, the plurality of supporting portions is configured to be spaced apart from the surface on which the stand is placed and the plurality of rollers is configured to be supported on the surface on which the stand is placed, and
wherein when the second stand unit moves downward, the plurality of rollers is configured to be spaced apart from the surface on which the stand is placed and the plurality of supporting portions is configured to be supported on the surface on which the stand is placed.

17. The display apparatus according to claim 16, wherein the first stand unit comprises:
a first base plate, the plurality of rollers being provided on the first base plate; and
an inner stand extending vertically from the first base plate and configured to couple with the fastening unit.

18. The display apparatus according to claim 17, wherein the second stand unit comprises:
a second base plate provided with a plurality of support portions, the second base plate being disposed on the first base plate; and
an outer stand extending vertically from the second base plate at an upper portion of the second base plate, the outer stand being movable in a vertical direction to accommodate the inner stand.

19. The display apparatus according to claim 18, wherein the outer stand comprises a protrusion provided on an upper portion thereof, and wherein the outer stand is vertically movable by a jig engaged with the protrusion, the jig being configured to move vertically.

20. The display apparatus according to claim 19, wherein when the jig is rotated in a first direction, the jig is configured to move upward, and the second stand unit is configured to move upward together with the jig, and
wherein when the jig is rotated in a second direction the jig is configured to move downward, and the second stand unit is configured to move downward together with the jig.
